(19) United States
(12) Patent Application Publication
(10) Pub. No.: US 2024/0051261 A1
(43) Pub. Date: Feb. 15, 2024

(54) FIRE-RESISTANT COMPOSITE SHEET

(71) Applicant: DUPONT SAFETY & CONSTRUCTION, INC., Wilmington, DE (US)

(72) Inventor: Dariusz Wlodzimierz Kawka, Midlothian, VA (US)

(73) Assignee: DUPONT SAFETY & CONSTRUCTION, INC., Wilmington, DE (US)

(21) Appl. No.: 17/884,334

(22) Filed: Aug. 9, 2022

(51) Int. Cl. B32B 5/26; B32B 5/02; B32B 7/12; B32B 5/06

(52) U.S. Cl. CPC B32B 5/275; B32B 5/024; B32B 5/022; B32B 7/12; B32B 5/06; B32B 5/073; B32B 2255/02; B32B 2255/26; B32B 2250/20; B32B 2255/28; B32B 2262/0261; B32B 2262/106; B32B 2262/101; B32B 2260/023; B32B 2260/046; B32B 2262/0269; B32B 2553/00; B32B 2307/3065; B32B 2307/718; B32B 2250/03

(57) ABSTRACT

A composite sheet comprises a textile component having a first surface and a second surface and a first polymeric coating on the first surface of the textile component wherein the textile component further comprises a first structure of at least one woven fabric of continuous filament yarns, the fabric having an areal weight of from about 70 to about 508 gsm, a second structure of a nonwoven fabric comprising a blend of discontinuous fibers of oxidized polyacrylonitrile fibers and silica fibers wherein the oxidized polyacrylonitrile fibers are present in an amount of from about 30 to about 70 weight percent of the combined weight of the oxidized polyacrylonitrile fibers and silica fibers, a third structure of at least one woven fabric of continuous filament yarns the fabric having an areal weight of from about 70 to about 508 gsm and, optionally, wherein the nonwoven fabric of the second structure is mechanically attached to at least one of the other fabric structures by an attachment means.

### BACKGROUND OF THE INVENTION

### 1. Field of the Invention

Disclosed embodiments pertain generally to a composite sheet having fire-resistant properties. The sheet is useful as curtain walls for fire-resistant cargo containers, particularly containers used in aircraft.

### 2. Description of Related Art

The amount of freight carried in both passenger and cargo aircraft has been increasing for a number of years. Along with this, there have been increasing concerns for fire risks within cargo containers due to a rise in the amount of power sources, such as a high density energy storage devices or other battery types, in cargo. Five recent developments of fire-resistant composite sheets for cargo container walls are described below.

U.S. Pat. No. 9,296,555 to Kawka and Chang is directed to a non-rigid composite sheet comprising in order (i) a first component having an areal density of from 88 to 678 gsm comprising a first fabric of filamentary yarns having a tenacity of at least 11 g/dtex and a UV and weather impervious first polymeric layer, (ii) a second component having an areal density of from 30 to 237 gsm comprising a flame resistant substrate and an inorganic refractory layer and (iii) a third component having an areal density of from 88 to 678 gsm comprising a second fabric of filamentary yarns having a tenacity of at least 11 g/dtex and an impact and scratch resistant second polymeric layer, the second fabric of the third component being adjacent to the refractory layer of the second component.

U.S. Pat. No. 9,302,845 to Kawka and Chang discloses a non-rigid composite sheet comprising in order a first component having an areal density of from 102 to 678 gsm comprising a first fabric of filamentary yarns having a tenacity of at least 11 g/dtex and a UV and weather impervious first polymeric layer, a second component having an areal density of from 10 to 170 gsm comprising a flame resistant inorganic refractory layer adjacent to the at least one protective polymeric layer and a third component having an areal density of from 102 to 678 gsm comprising a second fabric of filamentary yarns having a tenacity of at least 11 g/dtex and an impact and scratch resistant second polymeric layer, the second fabric of the third component being adjacent to the refractory layer of the second component.

U.S. Pat. No. 10,457,013 to Kawka and Perez teaches a non-rigid composite sheet comprising in order (i) a first component having an areal weight of from 88 to 678 gsm comprising a first fabric of filamentary yarns having a tenacity of at least 11 g/dtex and a UV and weather impervious first polymeric layer, (ii) a second component having an areal weight of from 120 to 430 gsm comprising a flame resistant paper and (iii) a third component having an areal weight of from 88 to 678 gsm comprising a second fabric of filamentary yarns having a tenacity of at least 11 g/dtex and an impact and scratch resistant second polymeric layer, the second fabric of the third component being adjacent to the paper of the second component.

U.S. Pat. No. 9,993,989 to Kawka describes a non-rigid composite sheet comprising in order (i) a first component comprising a first fabric of continuous filament yarns having a tenacity of at least 11 g/dtex and a first polymeric layer, (ii) a second component comprising at least one second fabric of continuous filament glass yarns, the second fabric being adjacent to the first fabric of the first component and (iii) a third component comprising a second polymeric layer.

U.S. Pat. No. 10,300,677 to Kawka pertains to a non-rigid composite sheet comprising in order (i) a first component comprising at least one first fabric of continuous filament yarns having a tenacity of at least 11 g/dtex and a first polymeric layer, (ii) a second component comprising at least one second fabric of continuous filament glass yarns, the at least one second fabric being adjacent to the at least one first fabric of the first component and (iii) a third component comprising a second polymeric layer.

However, there remains a need and desire for further fire-resistant composite sheets for cargo container walls that will provide improved fire protection. Further weight reductions are also desirable.

### BRIEF SUMMARY OF THE INVENTION

In one aspect, the present disclosure provides a composite sheet 11a or 11b comprising a textile component 12a or 12b having a first surface 13a or 13b or a second surface 14a or 14b and a first polymeric coating 15 on the first surface 13a or 13b of the textile component 12a or 12b. The textile component 12a or 12b further comprises
a fabric structure 16 of at least one woven fabric of continuous filament yarns, the fabric having an areal weight of from about 70 to about 508 gsm,
a fabric structure 17 of a nonwoven fabric comprising a blend of discontinuous oxidized polyacrylonitrile fibers and silica fibers, wherein the oxidized polyacrylonitrile fibers are present in an amount of from about 30 to about 70 weight percent of the combined weight of the oxidized polyacrylonitrile fibers and silica fibers, and
a fabric structure 18 of at least one woven fabric of continuous filament yarns, the fabric having an areal weight of from about 70 to about 508 gsm.

### BRIEF DESCRIPTION OF THE DRAWINGS

FIG. 1 is an exploded end view of a composite sheet 11a according to an exemplary embodiment.

FIG. 2 is an exploded end view of a composite sheet 11b according to an exemplary embodiment.

FIG. 3 is an end view of a textile component 12a showing stitching through three fabric structures 16-18 of the textile component 12a according to an exemplary embodiment.

FIG. 4 is an end view of a textile component 12a showing filament entanglement between three fabric structures 16-18 of the textile component 12a according to an exemplary embodiment.

### DETAILED DESCRIPTION OF THE INVENTION

In the following detailed description, reference is made to the accompanying drawings which form a part hereof, and which illustrate exemplary embodiments of the invention. These embodiments are described in sufficient detail to enable those of ordinary skill in the art to make and use them. It is also understood that structural, logical, or procedural changes may be made to the exemplary embodiments disclosed herein without departing from the spirit or scope of the invention.

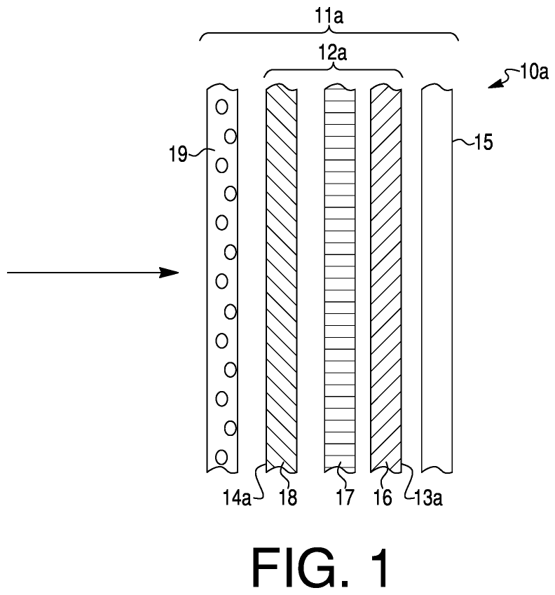

FIG. 1 shows generally at 10a an exemplary exploded end view of one embodiment of a composite fire-resistant sheet 11a. The composite sheet 11a comprises a textile component 12a having a first surface 13a and a second surface 14a and a polymeric coating 15 located on the first surface 13a of the textile component 12a. An optional second polymeric coating 19 may be located on the second surface 14a of textile component 12a.

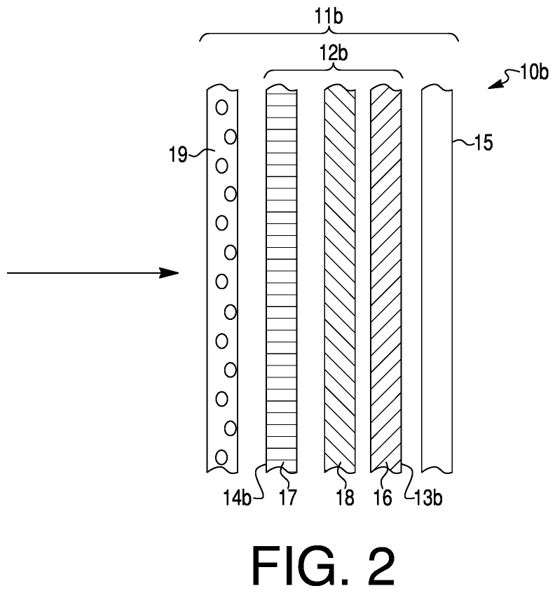

FIG. 2 shows generally at 10b an exemplary exploded end view of another embodiment of a composite fire-resistant sheet 11b. The composite sheet 11b comprises a textile component 12b having a first surface 13b and a second surface 14b and a polymeric coating 15 located on the first surface 13b of the textile component 12b. An optional second polymeric coating 19 may be located on the second surface 14b of textile component 12b.

### Textile Component

The textile component 12a or 12b comprises three different fabric structures.

Fabric structure 16 comprises at least one woven fabric of continuous filament yarns.

Fabric structure 17 is a nonwoven fabric comprising a blend of discontinuous fibers of oxidized polyacrylonitrile fibers and silica fibers. In some embodiments, the oxidized polyacrylonitrile fibers are present in an amount of from about 30 to about 70 weight percent of the combined weight of the oxidized polyacrylonitrile fibers and silica fibers, and in other embodiments of from about 40 to about 60 weight percent of the combined weight of the oxidized polyacrylonitrile fibers and silica fibers. In some embodiments, the nonwoven fabric has an areal weight of from about 100 to about 170 gsm, in other embodiments of from about 100 to about 240 gsm, and in other embodiments of from about 100 to about 305 gsm. Preferably, the fabric structure 17 comprises only one nonwoven fabric but more than one nonwoven fabric may be incorporated into the fabric structure 17.

The fabric structure 18 comprises at least one woven fabric of continuous filament yarns.

In FIG. 1, the fabric structure 17 is located between the fabric structure 16 and fabric structure 18. The fabric structure 17 of textile component 11a may be attached to the fabric structure 16 or fabric structure 18 or both the fabric structure 16 and fabric structure 18 by an attachment means. In other embodiments, as in FIG. 2, the fabric structure 18 is located between the fabric structure 16 and fabric structure 17. The fabric structure 18 of the textile component 12b may be attached to the fabric structure 16 or fabric structure 17 or to both the fabric structure 16 and fabric structure 17 by an attachment means.

Suitable attachment means for attaching two or all three of the fabric structures 16, 17, and 18 together include, but are not limited to, adhesion, stitching, or fiber entanglement.

Adhesion may be obtained by placing an adhesive, preferably an adhesive film, between one or more of the fabric structures 16, 17, and 18 and curing the adhesive or by impregnating one or more of the fabric structures 16, 17, and 18 with a matrix resin, placing the one or more impregnated fabric structures in contact with another fabric structure and curing the matrix resin.

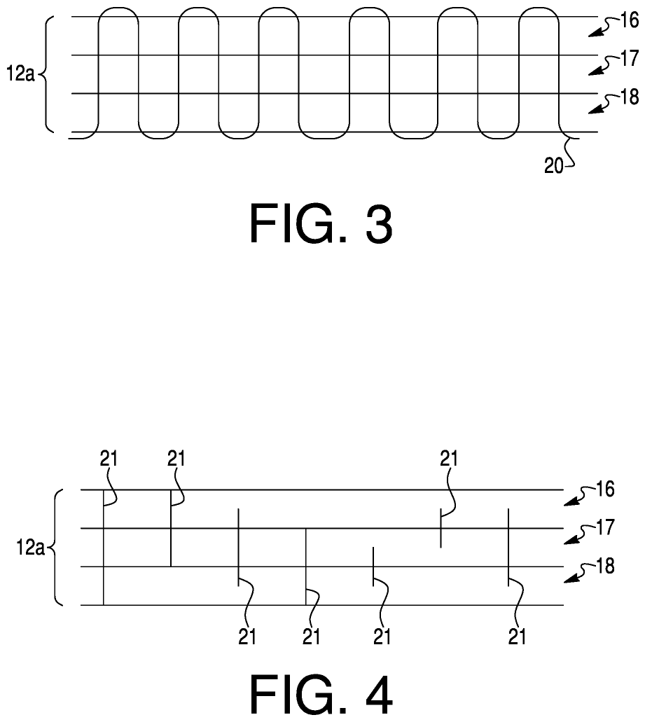

FIG. 3 shows a sectional view example of the stitching option where stitches 20 pass through the fabric structures 16 to 18 of the textile component 12a.

FIG. 4 shows a sectional view example of the fiber entanglement option. This is often referred to as needlepunching or needling. In this process, fine needle barbs repeatedly penetrate through the textile component 12a causing filaments 21 to reorientate and extend in the z-direction approximately perpendicular to the x-y plane of the textile component 12a. This intermingling of the filaments 21 among the different fabric structures 16, 17, and/or 18 improves flammability resistance of the textile component.

In some embodiments, some combination of adhesion, stitching, or fiber entanglement may be used as attachment means.

In a preferred embodiment, all three fabric structures 16, 17, and 18 are attached to each other by an attachment means.

FIGS. 1 and 2, show the fabric structures 16, 17, and 18 of textile component 12a or 12b arranged in a particular order. Other arrangements are also suitable, for example, fabric structure 16 may be positioned between fabric structure 17 and fabric structure 18.

The textile component 12a or 12b should preferably have an inter-fabric bond strength when subject to puncture of at least 11 kg/10 cm when tested according to ASTM D1876-08(2015)—Standard Test Method for Peel Resistance of Adhesives, i.e., there is no delamination between either the fabric structure 16 and fabric structure 17 or the fabric structure 16 and fabric structure 18 or the fabric structure 17 and fabric structure 18 until a pull strength of at least 11 kg/10 cm has been achieved.

In some embodiments, one or more of the fabric structures 16, 17, or 18 of the textile component 12a or 12b are impregnated with a matrix resin such that the resin is present in an amount of from about 5 to about 45 weight percent of the combined weight of resin and fiber in each of the one or more impregnated fabric structures, in other embodiments of from about 7 to about 40 weight percent of the combined weight of resin and fiber in each of the one or more impregnated fabric structures, in other embodiments of from about 7 to about 20 weight percent of the combined weight of resin and fiber in each of the one or more impregnated fabric structures, and in other embodiments of from about 15 to about 20 weight percent of the combined weight of resin and fiber in each of the one or more impregnated fabric structures. The matrix resin may be phenolic, flame-retarded epoxy, or flame retarded polyurethane. Bio-based resins may also be used such as bio-based perfluoroalkoxy copolymer, bio-based epoxy vitrimer, bio-based polyetherimide, lignin bio-based phenolic, bio-based polycarbonate, soybean based unsaturated polyester, bio-based benzoxazine, bio-based epoxy resin, and green polyethylene. The resin is cured as per the recommended cure cycle from the supplier. A continuous belt press is one example of equipment in which the curing process may be affected.

In one preferred embodiment, all three fabric structures 16, 17, and 18 are impregnated with a matrix resin. In yet another embodiment, all three fabric structures 16, 17 and 18 are attached to each other by an attachment means as well as being impregnated with a matrix resin.

Embodiments in which at least one fabric structure 16, 17, or 18 of the textile component 12a or 12b is impregnated with resin provides a composite sheet 11a or 11b that is rigid and that has a limited capability of being rolled up. Embodiments in which the textile component 12a or 12b is not impregnated with resin provides a composite sheet 11a or 11b that is semi-rigid, i.e., flexible and capable of being rolled up.

### Woven Fabrics

Suitable weave styles for the one or more woven fabrics of fabric structure 16 and fabric structure 18 respectively include plain weave, satin weave, basket weave, leno weave, or twill weave. One suitable fabric for the one or more woven fabrics of fabric structure 16 and fabric structure 18 is a scoured 230 gsm 17×17 pick count plain weave fabric made from 1500 denier Kevlar® 29 p-aramid yarn. Alternatively, the one or more woven fabrics of fabric structure 16 and fabric structure 18 may be a plain weave fabric comprising 555 dtex (500 denier) KM2+p-aramid yarns in an amount of 11 ends per cm (28 ends per inch) in both warp and weft directions. Where there is more than one woven fabric in the fabric structure 16 or fabric structure 18, these woven fabrics may be the same or different either in yarn composition and/or weave style. In some embodiments, the one or more woven fabrics of fabric structure 16 or fabric structure 18 have an areal weight of from about 70 to about 508 gsm (2.1 to 15 oz. per sq. yd.), in other embodiments from about 101 to about 373 gsm (3 to 11 oz. per sq. yd.), and in other embodiments from about 101 to about 170 gsm (3 to 5 oz. per sq. yd.). In some other embodiments, the one or more woven fabrics of fabric structure 18 have an areal weight of from about 170 to about 270 gsm (5 to 8 oz. per sq. yd.).

In some embodiments, the one or more woven fabrics of the fabric structure 16 and/or fabric structure 18 are scoured or heat cleaned after weaving. Such processes are well known in the textile industry to remove contaminants such as oil from the weaving process.

The one or more woven fabrics of the fabric structures 16 and 18 are made from multifilament yarns having a plurality of filaments. The yarns can be intertwined and/or twisted. For purposes herein, the term “filament” is defined as a relatively flexible, macroscopically homogeneous body having a high ratio of length to width across its cross-sectional area perpendicular to its length. The filament cross section can be any shape but is typically circular or bean shaped. Herein, the term “fiber” is used interchangeably with the term “filament” and, when relating to pick count, the term “end” is used interchangeably with the term “yarn.”

The filaments can be any length. Preferably the filaments are continuous. Multifilament yarn spun onto a bobbin in a package contains a plurality of continuous filaments. The multifilament yarn can be cut into staple fibers and made into a spun staple yarn suitable for use in the one or more woven fabrics of the fabric structure 16 and/or fabric structure 18. The staple fiber can have a length of about 1.5 to about 5 inches (about 3.8 cm to about 12.7 cm). The staple fiber can be straight (i.e., non-crimped) or crimped to have a saw tooth shaped crimp along its length, with a crimp (or repeating bend) frequency of about 3.5 to about 18 crimps per inch (about 1.4 to about 7.1 crimps per cm).

In some embodiments, the yarns of the one or more woven fabrics of fabric structures 16 and 18 have a yarn tenacity of at least about 11 grams per dtex and a modulus of at least about 100 grams per dtex. In some embodiments, the yarns of the one or more woven fabrics of fabric structures 16 and 18 have a linear density of from about 333 to about 2222 dtex (300 to 2000 denier), in other embodiments of from about 555 to about 1111 dtex (500 to 1000 denier), in other embodiments of about 555 dtex, and in other embodiments of about 1111 dtex.

The fibers of the yarns may be polymeric, inorganic or natural and may be made from any suitable material known in the art. In some embodiments, the fibers of the yarns may be aromatic polyamide, aromatic copolyamide, aliphatic polyamide, polyolefins, polyazoles, glass, carbon, multi-component fibers, and combinations thereof.

When the polymer is polyamide, aramid is preferred. As used herein, “aramid” is meant a polyamide polymer wherein at least 85% of the amide (—CONH—) linkages are attached directly to two aromatic rings. Para-aramid polymers are aramid polymers where the amide linkages are in the para-position relative to each other. One preferred para-aramid polymer is poly (paraphenylene terephthalamide) or PPD-T. Additives can be used with the aramid and, in fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. Suitable aramid fibers are described in Man-Made Fibres—Science and Technology, Volume 2, Section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

Other useful para-aramids include aramid copolymers resulting from the incorporation and/or substitution of other aromatic diamines and other aromatic diacid chlorides such as, for example, 2,6-naphthaloyl chloride or chloro- or dichloroterephthaloyl chloride or 3,4′-diaminodiphenylether. Another preferred para-aramid comprises aramid copolymers derived from 5(6)-amino-2-(p-aminophenyl) benzimidazole (DAPBI), para-phenylenediamine (PPD), and terephthaloyl dichloride (TCl or T, also commonly referred to as terephthaloyl chloride); such as, for example in U.S. Pat. Publ. No. 2014/0357834, Russian Patent Application No. 2,045,586 and other such fibers provided in, for example, Sugak et al., Fibre Chemistry Vol 31, No 1, 1999; U.S. Pat. No. 4,018,735; and WO 2008/061668, and US 2014/357834-A1.

Examples of para-aramid fibers that are commercially available include Kevlar® from DuPont in Wilmington, Delaware, and Twaron® from Teijin Aramid in Arnhem, Netherlands. Examples of aramid copolymer fibers include Armos® and Rusar® from Kamenskvolokno Company in Kamensk-Shakhtinskii, Russia.

Glass fibers may include “E” glass and “S” Glass. E-Glass is a commercially available low alkali glass. One typical composition consists of 54 weight % SiO₂, 14 weight % Al₂O₃, 22 weight % CaO/MgO, 10 weight % B₂O₃ and less than 2 weight % Na₂O/K₂O. Some other materials may also be present at impurity levels S-Glass is a commercially available magnesia-alumina-silicate glass. This composition is stiffer and stronger than E-glass and is commonly used in polymer matrix composites. Exemplary woven fabrics for fabric structure 18 include heat cleaned weave styles 7781 with E-glass yarn and 6781 with S-glass yarn.

A suitable carbon fiber is a standard or intermediate modulus fiber such as those available under the tradename Torayca from Toray Industries or HexTow from Hexcel Corporation. Typically, such fibers have 3,000 or 6,000 or 12,000 or 24,000 filaments per tow.

In some embodiments, the fabric structure 16 and/or the fabric structure 18 may optionally be treated with a fire-retardant ingredient. Suitable fire-retardant ingredients include, but are not limited to, antimony trioxide, halogenated flame retardants including tetrabromobisphenol A, polybrominated biphenyls, pentabrominateddiphenylether(oxide), octabrominateddiphenylether(oxide), decabrominateddiphenylyether(oxide), and hexabromocyclododecane. Phosphorus containing fire retardants are also widely used.

### Polymeric Coatings

The polymer of the first polymeric coating 15 or second polymeric coating 19 may be a thermoplastic polymer, thermoset polymer, or silicone rubber.

Suitable polymers include polyurethane, polyethylene, polypropylene, polyethylenenaphthalate, polyacrylonitrile, fluoropolymer, polyimide, polyketone, polyimide (Kapton®), polysulfone, polyarlenesulfide, liquid crystal polymer, polycarbonate, and ionomers such as ethylenemethacrylicacid copolymer (E/MAA).

Exemplary fluoropolymers include polyvinylfluoride (Tedlar®), ethylenechlorotrifluoroethylene copolymer (Halar®) and polytetrafluroethylene (Teflon®). Exemplary polyketones include polyetheretherketone (PEEK) and polyetherketoneketone (PEKK).

In one embodiment, the first polymeric coating 15 is polyurethane. In another embodiment, the second polymeric coating 19 is an ionomeric resin such as ethylenemethacrylicacid copolymer. In yet another embodiment, the first polymeric coating 15 is non-transparent and impervious to UV rays. By non-transparent and impervious to UV rays we mean that at least 95% of UV rays, more preferably at least 98% and most preferably 100% of UV rays are blocked especially those rays at the upper end of the UV spectrum.

In some embodiments, the first polymeric coating 15 and/or second polymeric coating 19 have an areal weight of about 17 to about 170 gsm (0.5 to 5 oz. per sq. yd.), in other embodiments from about 34 to about 136 gsm (1 to 4 oz. per sq. yd.), and in other embodiments from about 67 to about 102 gsm (2 to 3 oz. per sq. yd.).

Preferably, the first and second polymeric coatings 15 and 19 respectively may be polyurethane, silicone rubber, polyvinylchloride, or blends thereof. In some embodiments, the second polymeric coating 19 may be an ionomeric resin based on ethylene acid copolymer such as Surlyn®.

The first polymeric coating 15 contacts the first surface 13a or 13b of the textile component 12a or 12b. The first polymeric coating 15 provides chemical and environmental (i.e., weather and UV) resistance to both physical and chemical attack and permeation by liquids.

By chemical and environmental/weather resistant is meant that the ability of the polymeric coating to withstand, without excessive degradation, the effects of wind, rain, contaminants such as acidic and/or oily residues found in typical industrial areas, and sun exposure. Preferably, the first polymeric coating 15 has an enhanced ability to resist damage by chemical reactivity or solvent action from hydrocarbons, chemicals, ozone, bacteria, fungus, and moisture, as well as skin oils typically associated with operation and maintenance of a commercial aircraft.

By UV resistant is meant that, when exposed to ultraviolet radiation, the first polymeric coating 15 retains its appearance and physical integrity without an excessive degradation of its flexibility or mechanical properties (i.e., brittleness). Preferably, the polymeric layer blocks at least 95% of UV rays, more preferably at least 98%, and most preferably 100% of UV rays. UV imperviousness of the first polymeric coating 15 can be further mitigated by inclusion of additives in the polymeric material. Examples of such additives include fillers, colors, stabilizers, and lubricants. The outer surface of the first polymeric coating 15 that is not in contact with the fabric structure 16 may optionally be coated or treated with a UV blocking material.

Ultraviolet (UV) is an invisible band of radiation at the upper end of the visible light spectrum. At wavelengths ranging from 10 to 400 nm, ultraviolet (UV) starts at the end of visible light and ends at the beginning of X-rays. As the primary exposure of the composite sheet 11a or 11b to ultraviolet light is the sun, the most critical UV resistance is that to the lower-frequency, longer-wavelength rays.

Preferably, the first polymeric coating 15 has a soft, non-plastic feel that is ideal for products that come in contact with the human skin and maintains its toughness and flexibility over a wide temperature range, even at temperatures as low as −50° C. (−60° F.), over the life span of the product.

In some embodiments, the outer surface of the first polymeric coating 15, i.e., the surface that is not in contact with fabric structure 16, has a release value of no more than 263 N/m (1.5 lb./in), more preferably no more than 438 N/m (2.5 lb./in) when measured according to ASTM D2724—07(2011)e1 Standard Test Methods for Bonded, Fused, and Laminated Apparel Fabrics. This facilitates cleaning, label removal etc.

In some embodiments, fabric structure 16 may be bonded to the first polymeric coating 15 by means such as an adhesive, thermal bonding, or by fasteners. This adhesive may be a thermoplastic or thermoset resin. Thermoset resins include, but are not limited to, epoxy, epoxy novolac, phenolic, polyurethane, and polyimide. Thermoplastic resins include, but are not limited to, polyester, polyetherketone, polyetheretherketone, polyetherketoneketone, polyethersulfone and polyolefin. Thermoplastic resins are preferred.

Preferably, the adhesive may optionally contain up to about 40 weight percent of a flame retardant ingredient. Suitable flame retardant ingredients include, but are not limited to, antimony trioxide, halogenated flame retardants including tetrabromobisphenol A, polybrominated biphenyls, pentabrominateddiphenylether(oxide), octabrominateddiphenylether(oxide), decabrominateddiphenylyether(oxide), and hexabromocyclododecane. Phosphorus containing flame retardants are also widely used.

Preferably, the adhesive blocks at least about 95% of UV rays, more preferably at least about 98%, and most preferably about 100% of UV rays. The adhesive may further comprise fillers, colors, stabilizers, and other performance enhancing additives.

Preferably, the adhesive bond between the first polymeric coating 15 and the fabric structure 16 is at least about 263 N/m (1.5 lb./in). In some embodiments, the adhesive bond between the first polymeric coating 15 and the fabric structure 16 is at least about 438 N/m (2.5 lb./in), and in other embodiments about 876 N/m (5 lb./in).

The second polymeric coating 19 which is the innermost layer of the composite sheet 11a or 11b contacts the second surface 14a or 14b of the textile component 12a or 12b. This second polymeric coating 19 may also be pigmented and contain ultra-violet (UV) blocking agents. An acceptable UV resistance is the ability to withstand exposure to strong direct sunlight for 10 years without compromising basic mechanical and visual properties of the sheet. A suitable standard is ASTM G154-16 (UVA-340 Lamps, 16 hours of UV at 60±2° C. and 8 hours condensation at 50±2° C. over a time period of 240 hours.

In some embodiments, fabric structure 18 may be bonded to the second polymeric coating 19 (FIG. 1) or the nonwoven fabric structure 17 may be bonded to the second polymeric coating 19 (FIG. 2). A suitable bonding means may be an adhesive, thermal bonding, or by fasteners. Adhesives similar to those described above for bonding fabric structure 16 to the first polymeric coating 15 may be utilized here.

A typical coating for either the first or second polymeric coatings 15 and 19 has a thickness of about 75 micrometers and an areal weight of about 90 gsm. The coating should have a vertical flame flammability rating meeting UL 94V-0 and be able to withstand exposure from −40 to +60 degrees C. without compromising basic mechanical and visual properties such as flexibility, color, transparency, etc.

### Utility

The composite sheet 11a or 11b described herein has useful fire-resistant properties and is suitable as a curtain wall material in a cargo container, particularly containers used in aircraft. Aircraft cargo containers are frequently called unitary load devices (ULDs). In a preferred embodiment, when assembled into the container frame, the composite sheet 11a or 11b is positioned so that the fabric structure 18 of textile component 12a or the fabric structure 17 of textile component 12b is positioned to face a fire threat from the cargo as shown in FIGS. 1 and 2 respectively. The fire threat direction is shown by an arrow in FIGS. 1 and 2. The composite sheet 11a or 11b is compliant with the test methods described below.

The term “innermost” as used in this disclosure refers to that part of composite sheet 11a or 11b which, when the composite sheet is assembled into a cargo container, is facing the cargo. The term “outermost” as used in this disclosure refers to that part of composite sheet 11a or 11b which, when the composite sheet is assembled into a cargo container, is furthest away from the cargo.

Although the preferred orientation of the composite sheet 11a or 11b is that the fabric structure 18 of textile component 12a or the fabric structure 17 of textile component 12b is positioned to face a cargo fire threat, i.e., to contain internal fire inside the fire-resistant air cargo container, the composite sheet 11a or 11b would also be able to provide useful fire-resistant properties when the opposite side of the composite sheet 11a or 11b is exposed to a fire external to the cargo container.

### Test Methods

Flame penetration was measured according to 14 CFR 25.855 Appendix F Part III—Test Method to Determine Flame Penetration Resistance of Cargo Compartment Liner (ceiling position). This is referenced in the examples as “Test Method 1.”

The composite sheet was subjected to a flame test that replicated the temperature and air mass flux test conditions of test method FAA FAR 25.856(b), App. F, Part VII. The somewhat lower heat flux was compensated with a higher air mass flux to replicate a required thermo-mechanical stress level to be exerted on the flame barrier composite sheet during the burn-through test. This is referenced in the examples as “Test Method 2.”

A wash-dry cycle consisted of a 4 lb. load with each warm water wash cycle having a duration of 40 minutes. The detergent was 66 g of 1993AATCC Standard Reference Detergent. Each drying cycle lasted 40 minutes, the drying medium being forced cold air.

### EXAMPLES

The following examples are given to illustrate exemplary embodiments of the invention and should not be interpreted as limiting it in any way. All parts and percentages are by weight unless otherwise indicated. Examples prepared according to the process or processes described herein are indicated by numerical values. Control or Comparative Examples are indicated by letters.

In Examples 1-17, the textile component 12a or 12b was needlepunched once the three fabric structures 16, 17, and 18 of the textile component 12a or 12b were assembled together.

### Example 1

The fabric structure 16 of the textile component 12a was a plain weave p-aramid fabric woven from 1500 denier Kevlar® K29 yarn. This aramid fabric had 26 ends per inch in both warp and weft. The fabric structure 17 of the textile component 12a was a nonwoven fabric from Tex Tech Industries, North Monmouth, ME. This nonwoven fabric had a nominal weight of 102 gsm and comprised 50 weight percent of pre-oxidized polyacrylonitrile fibers type ZOLTEK™ OX and 50 weight percent of Beloctex™ silica fibers. The fabric structure 18 of the textile component 12a was a 190 gsm plain weave E-glass fabric (ECG). There was no first or second polymeric coatings 15 or 19 in this example. The textile component 12a was assembled as in FIG. 1. The textile component 12a was subjected to, and passed, Test Method 1. In this test, the fabric structure 18 was facing the flame.

### Example 2

This example was prepared as per Example 1 except that the fabric structure 18 of the textile component 12a was a 305 gsm 8-harness satin weave style 7781 E-glass fabric. The textile component 12a passed Test Method 1. In this test, the fabric structure 18 was facing the flame.

### Example 3

This example was prepared as per Example 1 except that the fabric structure 18 of the textile component 12a was a 305 gsm 8-harness satin weave style 6781 S-glass fabric. The textile component 12a passed Test Method 1. In this test, the fabric structure 18 was facing the flame.

### Example 4

This example was prepared as per Example 1 except that the fabric structure 18 of the textile component 12a was a 195 gsm 8-harness satin weave style E-glass fabric. In this test, the fabric structure 18 was facing the flame. The textile component 12a passed Test Method 1. Examples 2, 3 and 4 exhibit better structural integrity after flame exposure than Example 1.

A further observation between Examples 1, 2, 3 and 4 is that the fabric structure 16 of the textile component 12a of the test specimens from Examples 1 and 4 exhibited a greater propensity to crack open during the flame exposure than those of Examples 2 and 3.

For all four Examples 1 through 4, after the flame exposure, the glass fabric structure 18 exhibited a tendency to detach or peel away from the Kevlar® fabric structure 16.

### Example 5

The textile component 12a of Example 1 was impregnated with a phenolic resin GP® 445D05 RESI-SET® from Georgia Pacific Chemicals LLC, Atlanta, GA such that the resin content was 7% of the combined weights of resin plus fibers in the textile component 12a. The resin was cured to form a rigid sheet. The textile component 12a passed Test Method 2. In this test, the fabric structure 18 was facing the flame.

### Example 6

This example was prepared in a similar way to Example 5 except that the resin content was 40% of the combined weights of resin plus fibers in the textile component 12a. The resin was cured to form a rigid sheet. The textile component 12a passed Test Method 2. In this test, the fabric structure 18 was facing the flame.

### Example 7

This example was prepared as in Example 1. The textile component 12a passed Test Method 2 prior to and after being subjected to five wash-dry cycles. In this test, the fabric structure 18 was facing the flame.

### Example 8

The textile component 12b was assembled as in FIG. 2. The fabric structure 16 of the textile component 12b was a 230 gsm plain weave Kevlar® fabric woven from 1500 denier yarn having a pick count of 17 yarns per inch in both warp and weft. The fabric structure 17 of the textile component 12b was a nonwoven fabric as used in Example 1. The fabric structure 18 of the textile component 12b was a 195 gsm woven 8 harness satin E-glass fabric.

There was no first or second polymeric coatings 15 and 19 in this example. The textile component 12b was impregnated with GP® 445D05 RESI-SET® phenolic resin such that the resin content was 24.4 weight percent of the combined weight of resin plus fibers in the textile component 12b. The resin was cured to form a rigid sheet.

The textile component 12b was subjected to, and passed, Test Method 2.

Two samples of the textile component 12b were subjected to the wash-dry cycles as per Example 7 and two samples were not subjected to wash dry cycles to function as controls. When subjected to flame exposure as per Test Method 2, there was no noticeable performance difference between the washed and unwashed samples. There was also no obvious difference in appearance or signs of physical degradation between the four samples.

In all flame tests of this Example, the fabric structure 17 was facing the flame.

### Example 9

This example was prepared as Example 8 except that the fabric structure 17 had an areal weight of 170 gsm and the resin content was 26.6 weight percent of the combined weight of resin plus fibers in the textile component 12b. The resin was cured to form a rigid sheet.

The textile component 12b was subjected to, and passed, Test Method 2. In this test, the fabric structure 17 was facing the flame.

Again, there was no noticeable performance difference between the washed and unwashed samples when subjected to Test Method 2. Further, there was also no obvious difference in appearance or signs of physical degradation between the four samples.

However, the specimens from Example 8 exhibited a greater propensity to crack after flame exposure than those of Example 9. It was also observed that the test specimens subjected to the wash-dry cycles had less smoke and off-gassing during the flame test than unwashed test specimens. A further observation between Examples 8 and 9 is that, after flame exposure, the test specimens from Example 9 had better residual cohesive integrity than those from Example 8, i.e., the glass fabric structure 18 in Example 8 peeled off the Kevlar® fabric structure 16 unlike Example 9 where that did not happen.

### Example 10

This example was prepared as per Example 9 except that the fabric structure 18 of the textile component 12b was a 190 gsm plain weave E-glass fabric (ECG). Furthermore, the textile component 12b was not impregnated with resin nor subjected to wash cycles.

The textile component 12b was subjected to, and passed, Test Method 1. In this test, the fabric structure 17 was facing the flame.

### Example 11

This example was prepared as per Example 10 except that the fabric structure 18 of the textile component 12b was a 305 gsm 8-harness satin weave style 7781 E-glass fabric.

The textile component 12b was subjected to, and passed, Test Method 1. In this test, the fabric structure 17 was facing the flame.

There was no noticeable performance difference between Examples 10 and 11, nor there was any obvious difference in appearance or level of physical degradation between those two samples during and after flame exposure.

Examples 10 and 11 exhibited a similar post-flame exposure structural integrity comparable to that of Examples 3 and 4 but without the glass fabric structure 18 propensity to detach or peel away from the Kevlar® fabric structure 16 after the flame exposure.

### Example 12

This example was prepared as per Example 10. The textile component 12b passed Test Method 2 prior to and after being subjected to five wash-dry cycles. In this test, the fabric structure 17 was facing the flame.

### Example 13

This example was prepared as per Example 11. The textile component 12b passed Test Method 2 prior to and after being subjected to five wash-dry cycles.

There was no noticeable performance difference between the washed and unwashed Examples 12 and 13 when subjected to Test Method 2. Further, there was also no obvious difference in appearance or signs of physical degradation between the four samples during and after flame exposure. In this test, the fabric structure 17 was facing the flame.

Examples 12 and 13 exhibit similar post-flame exposure structural integrity without the glass fabric structure 18 propensity to detach or peel away from the Kevlar® fabric structure 16 after the flame exposure.

### Example 14

This example was prepared as per Example 10 except that a non-transparent 0.075 mm (3 mil) cast polyurethane film was thermally bonded to both the first surface 13b and the second surface 14b of textile component 12b thus providing first polymeric coating 15 and second polymeric coating 19 respectively.

The example was subjected to, and passed, Test Method 1. In this test, the second polymeric coating 19 was exposed to the flame with fabric structure 17 being next to polymeric coating 19.

### Example 15

This example was prepared as per Example 14 except that the textile component 12b was impregnated with a phenolic resin GP® 445D05 RESI-SET® such that the resin content was 24.5% of the combined weights of resin plus fibers in textile component 12b. The resin was cured. A non-transparent 0.075 mm (3 mil) cast polyurethane film was then thermally bonded to both the first surface 13b and the second surface 14b of the textile component 12b thus providing polymeric coating 15 and polymeric coating 19 respectively.

The example was subjected to, and passed, Test Method 2. In this test, the second polymeric coating 19 was exposed to the flame with fabric structure 17 being next to polymeric coating 19.

### Example 16

This example was prepared as per Example 10 except that a white non-transparent 0.025 mm (1 mil) polymeric Tedlar® film grade TWHB10E3 from DuPont was adhesively bonded to both the first surface 13b and the second surface 14b of textile component 12b thus providing polymeric coating 15 and polymeric coating 19 respectively. The adhesive used was a polyurethane adhesive film, type GH 140 FR TP-PU from Pioneer Marketing LLC, containing up to 30 weight percent of a flame retardant ingredient. The amount of adhesive applied was 34 gsm (1.0 oz/yd²).

The example was subjected to, and passed, Test Method 1. In this test, the side of the sample exposed to flame was the polymeric coating 19 with fabric structure 17 being next to polymeric coating 19.

### Example 17

This example was prepared as per Example 16 except that the textile component 12b was impregnated with phenolic resin GP® 445D05 RESI-SET® such that the resin content was 24.5% of the combined weights of resin plus fibers in textile component 12b. The resin was cured. A white non-transparent 0.025 mm (1 mil) polymeric Tedlar® film grade TWHB10E3 was adhesively bonded to both the first surface 13b and the second surface 14b of textile component 12b thus providing polymeric coating 15 and polymeric coating 19 respectively. A polyurethane adhesive film, type GH 140 FR TP-PU containing up to 30 weight percent of a flame retardant ingredient, was used as an adhesive to bond the first polymer coating 15 and second polymeric coating 19 to their respective fabric structures. The amount of adhesive applied was 34 gsm (1.0 oz/yd².

The example was subjected to, and passed, Test Method 2. In this test, the second polymeric layer 19 was the side exposed to the flame with fabric structure 17 being next to polymeric coating 19.

### Comparative Example A

Comparative Example A was prepared as per Example 1 except that the fabric structure 17 was omitted. The fabric structure 16 and fabric structure 18 were not mechanically entangled by needlepunching. This example failed Test Method 1 thus demonstrating the benefit provided by fabric structure 17 in delivering enhanced flame resistance properties. In this Example, fabric structure 18 was facing the flame.

### Comparative Example B

This was prepared as per Example 9 except that the fabric structure 18, the glass fabric, was omitted in the textile component 12b. The two fabrics of the textile component 12b were subjected to needlepunching. Further, the textile component 12b was not impregnated with resin and the assembled textile component 12b was not subjected to wash cycles. This Example failed Test Method 1. In this Example, fabric structure 17 was facing the flame.

1. A composite sheet comprising a textile component having a first surface and a second surface and a first polymeric coating on the first surface of the textile component wherein the textile component further comprises
a first structure of at least one woven fabric of continuous filament yarns, the fabric having an areal weight of from about 70 to about 508 gsm,
a second structure of a nonwoven fabric comprising a blend of discontinuous fibers of oxidized polyacrylonitrile fibers and silica fibers, wherein the oxidized polyacrylonitrile fibers are present in an amount of from about 30 to about 70 weight percent of the combined weight of the oxidized polyacrylonitrile fibers and silica fibers, and
a third structure of at least one woven fabric of continuous filament yarns, the fabric having an areal weight of from about 70 to about 508 gsm.

2. The composite sheet of claim 1, further comprising a second polymeric coating on the second surface of the textile component.

3. The textile component of claim 1, wherein the filaments of the at least one woven fabric of the first structure are of aromatic polyamide, aromatic copolyamide, glass, carbon, or aliphatic polyamide.

4. The textile component of claim 1, wherein the filaments of the at least one woven fabric of the third structure are of glass, aromatic polyamide, aromatic copolyamide, carbon, or aliphatic polyamide.

5. The composite sheet of claim 1, wherein at least one of the first structure, second structure, or third structure is impregnated with a matrix resin such that the resin is present in an amount of from about 5 to about 45 weight percent of the combined weight of the resin and fiber in the at least one of the first structure, second structure, or third structure.

6. The composite sheet of claim 1, wherein the first polymeric coating 15 is polyurethane, silicone rubber, polyvinylchloride, or a blend thereof.

7. The composite sheet of claim 1, wherein the second structure is attached to the first structure or third structure or both the first structure and third structure by an attachment means.

8. The composite sheet of claim 1, wherein the third structure is attached to the first structure or second structure or to both the first structure and second structure by an attachment means.

9. The composite sheet of claim 2, wherein the second polymeric coating 19 is polyurethane, silicone rubber, polyvinylchloride, ethylene acid copolymer, or blends thereof.

10. The textile component of claim 3, wherein the aromatic polyamide filaments are p-aramid.

11. The composite sheet of claim 5, wherein the matrix resin is phenolic, flame-retarded epoxy, flame retarded polyurethane, or bio-based.

12. The composite sheet of claim 7, wherein the attachment means is by adhesion, stitching, fiber entanglement, or a combination thereof.

13. The composite sheet of claim 8, wherein the attachment means is adhesion, stitching, fiber entanglement, or a combination thereof.

14. A cargo container comprising the composite sheet of claim 1.
